(19) United States
(12) Patent Application Publication
(10) Pub. No.: US 2006/0262092 A1
(43) Pub. Date: Nov. 23, 2006

(54) MOUSE USING SOUND FREQUENCY TRANSMISSION

(76) Inventor: Shih-Sheng Chang, Taichung County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/161,725

(22) Filed: Aug. 15, 2005

(30) Foreign Application Priority Data
May 19, 2005 (TW) 94116255

(51) Int. Cl. G09G 5/08

(52) U.S. Cl. 345/163

(57) ABSTRACT

A mouse using sound frequency transmission is disclosed. By pressing a key or rolling a wheel in the mouse, a plurality of sound-sending elements with different sound frequencies is knocked to produce a plurality of sound frequency signals. These sound frequency signals are received and transformed by a receiver connected with a computer. Therefore, the moving signals produced by the mouse are able to be transferred to the computer to achieve the purpose of controlling the cursor in the computer or executing computer functions. Therefore, the inconvenience of using batteries to supply power in a conventional mouse can be improved.

### CROSS-REFERENCE TO RELATED APPLICATION

This application claims the priority benefit of Taiwan application serial no. 94116255, filed on May 19, 2005. All disclosure of the Taiwan application is incorporated herein by reference.

### BACKGROUND OF THE INVENTION

1. Field of Invention

The present invention relates to a mouse. More particularly, the present invention relates to a mouse using sound frequency to transfer signals.

2. Description of Related Art

The current computers all have the mouse connected externally to the computer to control the cursor on the screen to control the computer operations, wherein the type of data transmission in the mouse has upgraded from the conventional wire connection to wireless transmission.

FIG. 1 is a schematic diagram showing a wireless mouse while sending and receiving signals, wherein the mouse 100 includes a key 101 and a key 102 for selecting the functions in the computer 110; a wheel 103 for scrolling the screen of the computer 100; and an x-y axis wheel 104 to generate a moving distance according to the movement of the mouse, which is transformed into a moving signal by the sender 105, and transferred to the antenna 130 connected to the computer 100 through the radio frequency (RF) signal. Finally, the receiver 120 transforms the RF signal into an electric signal and transfers it to the computer 100 to further control the movement of the cursor on the screen of the computer 110 or execute the functions of the computer 110.

However, almost all the common wireless mouse in the current market need a battery to supply power to send RF signal to the receiver connected to the computer. The battery not only brings in extra expense for users, but also causes environmental pollution.

In addition, there is also a type of mouse that does not require battery, but needs to be configured on a specific board to obtain the necessary power through power induction. Therefore, the type of mouse can be used only on the computer with such board, which is also a burden and inconvenient to use.

### SUMMARY OF THE INVENTION

Accordingly, the present invention is directed to a mouse using sound frequency transmission, and the moving signals produced by the mouse is transferred to the computer by RF transmission to achieve the purpose of controlling the cursor in the computer or executing computer functions.

The present invention provides a mouse using sound frequency transmission, suitable for controlling a cursor in a computer screen, compromising a key to select one function in the computer monitor by knocking; a first sound-sending element used to produce a first sound frequency signal when the key is pressed; a second sound-sending element used to produce a second sound frequency signal when the key is released; a rolling wheel used to roll according to the movement of the mouse to control the cursor in the computer screen; a third sound-sending element used to produce a third sound frequency signal by rolling the wheel; and a receiver connected to the mainframe, used to receive the first sound frequency signal, the second sound frequency signal and the third sound frequency signal.

The mouse using the sound frequency transmission according to the embodiment of the present invention, further includes a plurality of fourth sound-sending elements used to produce a plurality of fourth sound frequency signals corresponding to a plurality of rolling directions of the wheel.

In the mouse using sound frequency transmission according to the embodiment of the present invention, the aforementioned rolling directions include positive x axis, negative x axis, positive y axis and negative y axis.

In the mouse using sound frequency transmission according to the embodiment of the present invention, the aforementioned mouse is a computer mouse.

In the mouse using sound frequency transmission according to the embodiment of the present invention, the aforementioned receiver is a microphone.

In the mouse using sound frequency transmission according to the embodiment of the present invention, the aforementioned receiver further includes a processor used to transform the first sound frequency signal and the second sound frequency signal into computer signals and transfer them to the computer.

In the present invention, by pressing a key or rolling a wheel in the mouse, a plurality of sound-sending elements with different sound frequencies are knocked to produce a plurality of sound frequency signals. These sound frequency signals are received and transformed by a receiver connected with a computer. Therefore, the moving signals produced by the mouse can be transferred to the computer to achieve the purpose of controlling the cursor in the computer or executing computer functions.

In order to the make the aforementioned and other objects, features and advantages of the present invention comprehensible, a preferred embodiment accompanied with figures is described in detail below.

### BRIEF DESCRIPTION OF THE DRAWINGS

FIG. 1 is a schematic diagram showing a wireless mouse when sending and receiving signals.

FIG. 2 is a schematic diagram showing a mouse using sound frequency transmission when sending and receiving signals according to one embodiment of the present invention.

FIGS. 3(a) and 3(b) are structural diagrams of the key in the mouse using sound frequency transmission according to one embodiment of the present invention.

FIG. 4 is a structural diagram of the wheel in the mouse using sound frequency transmission according to one embodiment of the present invention.

FIG. 5 is a distribution diagram of the sound frequencies produced by the mouse according to one embodiment of the present invention.

### DESCRIPTION OF EMBODIMENTS

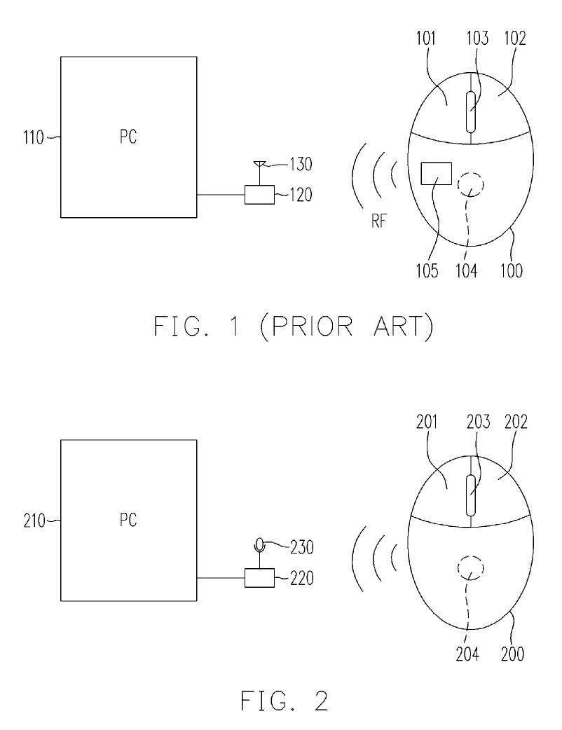

FIG. 2 is a schematic diagram showing a mouse using sound frequency transmission when sending and receiving signals according to one embodiment of the present invention, wherein the key 201, the key 202, the wheel 203, and the x-y axis wheel 204 in the mouse 200 have the same functions as the key 101, the key 102, the wheel 103, and the x-y axis wheel 104 in the mouse 100 in FIG. 1, so the description of those is omitted here. However, the means of producing the signals are different. The key 201, the key 202, the wheel 203, and the x-y axis wheel 204 in the embodiment each includes one or a plurality of sound-sending elements, and these sound-sending elements all have different sound frequencies. Therefore, when a user presses down the key 201 or the key 202 and rolls the wheel 203 or the x-y axis wheel 204 in the mouse, the signals with different sound frequencies are produced. These sound frequency signals are received by the microphone 230 connected with the computer 210, and these sound frequency signals are transformed into the moving signals accessible to the computer 210 by the receiver 220. Wherein the receiver 220 includes a processor, used to transform the sound frequency signals into computer signals and transfer the computer signals to the computer 210 to achieve the purpose of controlling the cursor in the computer 210 or executing functions in the computer 210. The aforementioned mouse 200 is only one of the embodiments of the present invention, and the present invention is not limited thereto. The users can use other types of mouse according to the actual requirement without departing from the scope or spirit of the present invention.

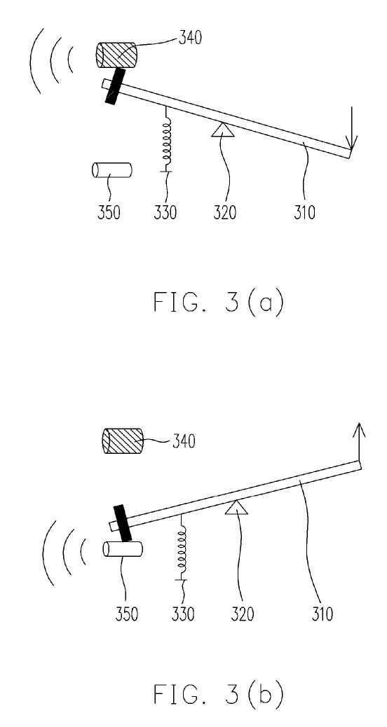

FIG. 3 is a structural diagram of the key in the mouse using sound frequency transmission according to one embodiment of the present invention. When the key is pressed down (as shown in FIG. 3(a)), the reed 310 would be held up by the supporting point 320 to knock the first sound-sending element 340 located on the upper edge of the reed 310, and a first sound frequency signal is produced by the first sound-sending element 340. At this time, the spring 330 is elongated by an external force.

In addition, when the key is released (as shown in FIG. 3(b)), the reed 310 is retrieved by the elastic force of the spring so as to knock the second sound-sending element 350 located under the lower edge of the reed 310, and a second sound frequency signal is produced by the second sound-sending element 350. Wherein, the first sound-sending element 340 and the second sound-sending element 350 are fabricated by different materials and with different forms and appearances, so that they have different sound frequencies and can produce different sound frequency signals.

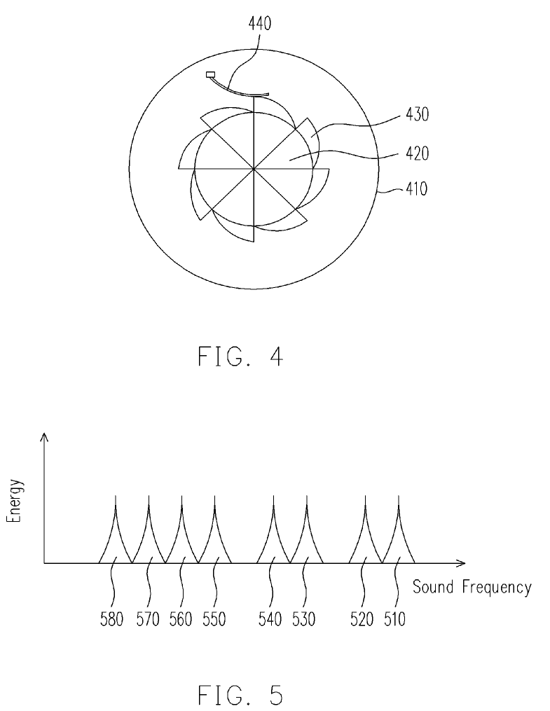

FIG. 4 is a structural diagram of the wheel in the mouse using sound frequency transmission according to one embodiment of the present invention, wherein the wheel 410 includes a ratchet wheel 420 and a pawl 440, and the ratchet wheel 420 also includes a plurality of ratchets 430. When a user rolls the wheel 410 in a positive direction, the pawl 440 would knock a plurality of ratchets 430 of the ratchet wheel 420 and produce a third sound frequency signal; if a user rolls the wheel 410 in reverse direction, the pawl 440 would be jammed in the groove between the ratchets 430 of the ratchet wheel 420 and then further push the ratchet wheel 420 without producing any sound.

In addition, the wheel 410 in the embodiment can also use ratchet wheels with different rolling directions (for example, positive x axis and negative x axis) to produce sounds of bidirectional rolling, and also can use ratchet wheels with different rolling directions (including positive x axis direction, negative x axis direction, positive y axis direction and negative y axis direction) in two directions (for example, x axis direction and y axis direction) to produce sounds of bidirectional rolling. And, those ratchet wheels with different rolling directions are fabricated by different materials and with different forms and appearances, so that they have different sound frequency signals and can produce different moving signals. The method can be applied in the x-y axis wheel to produce the moving signal according to the direction and distance of the movement of the mouse, to control the computer cursor.

FIG. 5 is a distribution diagram of the sound frequencies produced by the mouse according to one embodiment of the present invention, wherein the x coordinate represents the sound frequency, and the y coordinate represents the energy. In addition, the sound frequency wave 510 and the sound frequency wave 520 respectively represent the sound frequencies produced when the key is pressed down and released, while the sound frequency wave 530 and the sound frequency wave 540 respectively represent the sound frequencies produced when the wheel is rolled in positive and reverse direction. In addition, the sound frequency wave 550, the sound frequency wave 560, the sound frequency wave 570 and the sound frequency wave 580 respectively represent the sound frequencies produced when rolling the x axis wheel in positive and reverse direction and rolling the y axis wheel in positive and reverse direction. Accordingly, the different control signals of moving signals or function signals can be distinguished by the different sound frequencies to achieve the controlling purpose as provided in a common mouse.

In summary, the present invention provides a mouse using sound frequency transmission. By pressing a key or rolling a wheel in the mouse, a plurality of sound-sending elements with different sound frequencies is knocked to produce a plurality of sound frequency signals. These sound frequency signals are received and transformed by a receiver connected with a computer. Therefore, the moving signals produced by the mouse are able to be transferred to the computer to achieve the purpose of controlling the cursor in the computer or executing computer functions. Therefore, the inconvenience of using batteries to supply power in a conventional mouse can be improved.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A mouse using sound frequency transmission, suitable for controlling a cursor in a computer screen, the mouse comprising:
a key, for selecting one function in the computer screen by means of knocking;
a first sound-sending element, for producing a first sound frequency signal when the key is pressed;
a second sound-sending element, for producing a second sound frequency signal when the key is released;
a rolling wheel, for rolling according to the movement of the mouse to control the cursor in the computer screen;
a third sound-sending element, for producing a third sound frequency signal by rolling the wheel; and
a receiver connected to the computer, for receiving the first sound frequency signal, the second sound frequency signal and the third sound frequency signal.

2. The mouse using sound frequency transmission as claimed in claim 1, further comprising a plurality of fourth sound-sending elements for producing a plurality of fourth sound frequency signals corresponding to a plurality of rolling directions of the wheel.

3. The mouse using sound frequency transmission as claimed in claim 2, wherein the aforementioned rolling directions include positive x axis, negative x axis, positive y axis and negative y axis directions.

4. The mouse using sound frequency transmission as claimed in claim 1, wherein the mouse is a computer mouse.

5. The mouse using sound frequency transmission as claimed in claim 1, wherein the receiver is a microphone.

6. The mouse using sound frequency transmission as claimed in claim 1, wherein the receiver further comprises a processor for transforming the first sound frequency signal, the second sound frequency signal and the third sound frequency signal into computer signals and transfer the computer signals to the mainframe.
